(19) United States
(12) Patent Application Publication
(10) Pub. No.: US 2023/0117952 A1
(43) Pub. Date: Apr. 20, 2023

(54) Flexible Display Cover Substrate

(71) Applicant: MICROCOSM TECHNOLOGY CO., LTD., Tainan City (TW)

(72) Inventors: Chun-Yao Ou, Tainan City (TW); Tang-Chieh Huang, Tainan City (TW)

(73) Assignee: MICROCOSM TECHNOLOGY CO., LTD., Tainan City (TW)

(21) Appl. No.: 17/954,709

(22) Filed: Sep. 28, 2022

(30) Foreign Application Priority Data
Oct. 18, 2021 (TW) 110138554

(51) Int. Cl. C08J 7/046

(52) U.S. Cl. CPC C08J 7/046; C08J 2379/08; C08J 2435/02

(57) ABSTRACT

The present invention provides a flexible display cover substrate, which comprises a transparent polyimide film; and a device protection layer formed by curing a hard coating composition and disposed on at least one surface of the transparent polyimide film. The hard coating composition includes a hydrophobic UV-curable resin, an antistatic agent, a compound with three or more reactive functional groups, an elastic oligomer, an initiator and a modified inorganic nanoparticle. According to the present invention, a flexible display cover substrate with low haze and good bending resistance can be obtained.

### BACKGROUND OF THE INVENTION

This application claims priority under 35 U.S.C. § 119 to Taiwanese Patent Application No. 110138554, filed Oct. 18, 2021, the entirety of which is incorporated by reference herein.

### FIELD OF THE INVENTION

The present invention relates to a flexible display cover substrate and, in particular, to a flexible display cover substrate with excellent bending performance.

### DESCRIPTION OF THE PRIOR ART

In recent years, the development of displays has gradually developed from thinning to a flexible display that can be bent and deformed. During such development process, the cover substrate used in flexible displays is no longer a traditional glass substrate, but a flexible substrate made of bendable and pliable materials (i.e., flexible materials) such as plastics. However, the flexible display is prone to wear and scratches on the cover substrate during the deformation process, thereby causing fogging or damage to the display area. In order to solve this problem, a layer of acrylic-based or epoxy-based organic hardened film is generally coated on the surface of the plastic material as a protective layer to improve the hardness of the material. However, such organic hardened film is not flexible and has problems of surface cracking in both bending and abrasion testing.

In order to make hard coatings have both flexible bending resistance and scratch resistance, according to the relational formula between film properties and wear resistance proposed by Bull et al. in 1988:

L_{c2}=A/(vμ)*(2EWa/t)^{0.5}

wherein

L_{c2}: the minimum load for scratching hard coatings;

A: area of the brushed region of hard coatings;

v: Poisson's ratio of hard coatings;

μ: friction coefficient of hard coatings;

E: elastic modulus of hard coatings;

Wa: adhesion energy between hard coatings and the substrate;

t: film thickness of hard coatings,

by chemically modifying the surface chemical composition of hard coatings, the surface free energy can be reduced without affecting the flexibility and bending resistance of hard coatings. Commonly used hydrophobic compounds for hard coatings are: organosilicon compounds and fluorides. The water contact angle of hard coatings containing organosilicon compounds is generally less than or equal to 100°, and the hydrophobicity is normal. Because fluorine is the most electronegative in the periodic table of elements, the hard coating containing organic fluoride can make the water contact angle greater than or equal to 100°, which can more effectively reduce the surface energy, thereby reducing the friction coefficient.

By utilizing components with different surface free energies, such as fluoride and other resins (e.g., acrylate resins), to prepare multi-component coatings, after coating, components migrate in the system as the solvent evaporates from the coating, and the component with large surface energy (acrylate resin) migrates to the surface of the substrate; the component with small surface energy (fluoride) migrates to the surface, resulting in a gradient change of components in the hard coating. Fluorides with low surface energy are enriched on the surface, and acrylate resins with high surface energy are enriched on the surface of the substrate, resulting in interfacial-free layering within the hard coating. Such self-layering system can reduce adhesion problems between the hard coating and the substrate. Most of the fluorides are distributed at the surface of the hard coating, which effectively exerts the characteristics of fluoride in scratch and abrasion resistance. If the fluoride contains active groups that can react with the acrylate resin, it can further improve the scratch and abrasion resistance. However, excessive active groups will increase the mutual solubility of fluoride and acrylate resin, thereby reducing the concentration of fluoride at the surface of the cured film, resulting in reduced scratch and abrasion resistance. With the requirement of scratch and abrasion resistance, the number of reciprocations has been increasing, and the molecular weight of the fluoride must also reach more than or equal to 1000, which causes the fluoride to agglomerate after the wet film is dried, resulting in an increase in the haze of the cured film. Therefore, other solid components of the hard coating must have good compatibility with the fluoride.

The fluoride with high equivalent of active groups is bonded to the surface of the hard coating, which limits the crosslinking density of the hard coating surface and is not conducive to the eraser-resistant reciprocating abrasion test. The mutual friction of the eraser and the hard coating belongs to adhesive wear, and the abrasion chips are easily adsorbed on the hard coating due to electrostatic force, resulting in increased friction. For non-conductor hard coatings, the higher the sheet resistance value is, the less the electrostatic charges are easily dissipated, so impurities are likely to remain, such as chips due to electrostatic adsorption, thereby increasing the friction force during the abrasion process.

Based on the above, developing a flexible display cover substrate with excellent bending performance and scratch and abrasion resistance is an important subject of currently desired research.

### SUMMARY OF THE INVENTION

In view of the above-mentioned technical problems, an object of the present invention is to provide a flexible display cover substrate, which can have both good scratch wear (steel wool) resistance and adhesion wear (Eraser) resistance without affecting the bending resistance.

To achieve the above object, the present invention provides a flexible display cover substrate, which comprises a transparent polyimide film; and a device protection layer formed by curing a hard coating composition and disposed on at least one surface of the transparent polyimide film. The hard coating composition includes a hydrophobic UV-curable resin, an antistatic agent, a compound with three or more reactive functional groups, an elastic oligomer, an initiator and a modified inorganic nanoparticle, wherein a weight ratio of the compound with three or more reactive functional groups to the elastic oligomer ranges from 0.25 to 3.

Preferably, the hydrophobic UV-curable resin comprises a fluorine-based UV-curable resin or a fluorine-polysiloxane-based UV-curable resin.

Preferably, the hydrophobic UV-curable resin accounts for 0.1 to 10 wt % of a total amount of the hard coating composition.

Preferably, the antistatic agent comprises an organic salt compound.

Preferably, the antistatic agent accounts for 0.1 to 5 wt % of a total amount of the hard coating composition.

Preferably, the compound with three or more reactive functional groups comprises a compound having three or more (meth)acrylate groups.

Preferably, the elastic oligomer comprises an urethane (meth)acrylate oligomer or an oligomer of urethane (meth)acrylates containing silicon.

Preferably, the modified inorganic nanoparticle comprises an inorganic nanoparticle modified with a silane coupling agent.

Preferably, a total amount of the compound with three or more reactive functional groups, the elastic oligomer and the initiator accounts for 10 to 95 wt % of a total amount of the hard coating composition.

Preferably, the flexible display cover substrate has a water drop angle of greater than 105°.

Preferably, the flexible display cover substrate has a water drop angle of 100° or more after being brushed with an eraser.

The flexible display cover substrate of the present invention has a device protection layer with a specific composition, so it has excellent performance in flexibility. After bending 100,000 times with a radius of curvature of 1 mm, no crack is generated in the device protection layer. At the same time, the device protective layer is formed from a composition containing a hydrophobic UV-curable resin and an antistatic agent, which can improve the scratch resistance and abrasion resistance of the flexible display cover substrate without affecting the bending resistance of the screen.

### BRIEF DESCRIPTION OF THE DRAWINGS

FIG. 1 is a schematic view of the flexible display cover substrate of the present invention.

### DETAILED DESCRIPTION OF THE EMBODIMENTS

As used herein, a range represented by “one value to another value” is a general representation that avoids listing all the values in the range in the specification. Therefore, the recitation of a particular numerical range includes any numerical value within the numerical range and a smaller numerical range defined by any numerical value within the numerical range, as if the arbitrary numerical value and the smaller numerical range were expressly written in the specification. Hereinafter, the embodiments are given as examples in which the present invention can be actually implemented. However, these embodiments are merely illustrative, and the present disclosure is not limited thereto.

The present invention provides a flexible display cover substrate, which comprises a transparent polyimide film; and a device protection layer formed by curing a hard coating composition and disposed on at least one surface of the transparent polyimide film. The hard coating composition includes a hydrophobic UV-curable resin, an antistatic agent, a compound with three or more reactive functional groups, an elastic oligomer, an initiator and a modified inorganic nanoparticle, wherein a weight ratio of the compound with three or more reactive functional groups to the elastic oligomer ranges from 0.25 to 3.

<Transparent Polyimide Film>

The polyimide of the present invention can be composed of a unit represented by the following formula (1):

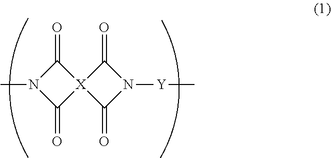

In the above formula (1), X is a group remaining after two —C(O)—O—C(O)— are removed from a dianhydride. Examples of the dianhydride may include, but are not limited to: 2,2′-bis-(3,4-dicarboxyphenyl)hexafluoropropane dianhydride (6FDA), 4,4′-diphenyl ether tetraanhydride (ODPA), biphenyl tetracarboxylic dianhydride (BPDA), benzophenone tetracarboxylic dianhydride (BTDA), cyclobutane tetracarboxylic dianhydride (CBDA), cyclopentane tetracarboxylic dianhydride (CPDA), 3,3′,4,4′-diphenylsulfone tetracarboxylic dianhydride (DSDA), 4,4′-(4,4′-isopropyldiphenoxy)bis(phthalic anhydride) (BPADA), 2,2-bis[4-(3,4-dicarboxyphenoxy)phenyl]hexafluoroisopropane dianhydride (HFBPADA), ethylene glycol bis-anhydro trimellitate) (TMEG), propylene glycol bis(trimellitic anhydride) (TMPG), bicyclo[2.2.1]heptane-2,3,5,6-tetracarboxylic dianhydride (BHDA), bicyclo[2.2.2]oct-7-ene-2,3,5,6-tetracarboxylic dianhydride (BOTDA), bicyclo[2.2.2]octane-2,3,5,6-tetracarboxylic dianhydride (BODA), etc. These dianhydrides can be used alone or in combination of two or more thereof. In a preferred embodiment, the polyimide of the present invention is prepared by using two or more dianhydrides.

In the above formula (1), Y is a group remaining after two —NH₂ are removed from a diamine. Examples of the diamine may include, but are not limited to: bis[4-(4-aminophenoxy)phenyl]sulfone (BAPS), 2,2′-bis[4-(4-aminophenoxy) phenyl]propane (BAPP), 2,2-bis[4-(4-aminophenoxy)phenyl]-1,1,1,3,3,3-hexafluoropropane (APHF), 2, 2′-bis(trifluoromethyl)benzidine (TFMB), 4,4′-diaminodiphenyl ether (ODA), diamino diphenyl sulfone (such as: 3DDS, 4DDS), 2,2-bis(4-aminophenyl)hexafluoropropane (BISAF), cyclohexanediamine (CHDA), 1,3-bis(3-aminophenoxy)benzene (TPE-M), 1,3-bis(4-aminophenoxy)benzene (TPE-R), 1,4-bis(3-aminophenoxy)benzene, 1,4-bis(4-aminophenoxy)benzene (TPE-Q) etc. These diamines can be used alone or in combination of two or more thereof. In a preferred embodiment, the polyimide of the present invention is prepared by using two or more diamines.

As to the polymerization method, the dianhydride and the diamine can be individually dissolved in a solvent, and then the dissolved dianhydride and the dissolved diamine are mixed and reacted to obtain a polyamic acid resin (polyimide resin precursor). The solvent can be an aprotic solvent, such as N,N-dimethylacetamide, N,N-diethylacetamide, N,N-dimethylformamide, N-methyl-2-pyrrolidone, etc., but is not limited thereto, and other suitable aprotic solvents can also be used.

The method of imidization can use high temperature curing, such as continuous or staged heating of the polyamic acid resin (polyimide resin precursor). When the polyimide resin is to be made into a film or an insulating layer, the polyamic acid resin (polyimide resin precursor) can be spread on the substrate first, and then the entire substrate is sent into an oven for heating and curing. A chemical ring closure method can also be used, that is, under nitrogen or oxygen, an unlimited basic reagent (such as pyridine, triethylamine or N,N-diisopropylethylamine, etc.) and a dehydrating reagent (such as: acetic anhydride) are added into the polyamic acid resin. After the reaction is completed, the colloid is washed with water and filtered to obtain a polyimide powder, which is then dissolved in a solvent. In addition, a heating ring closure method can be used, which adds an azeotropic agent (such as toluene or xylene) to the polyamic acid resin, raises the temperature to 180° C., and removes the water and the azeotropic agent produced by the ring closure of the polyamic acid resin. After the reaction is completed, the polyimide resin solution can be obtained.

In a preferred embodiment, the thickness of the transparent polyimide film is between 25 μm and 100 μm, and the total light transmittance is above 90%. The transparent polyimide film of the present invention may or may not contain one or more (such as: two or more, three or more) ultraviolet absorbers. The ultraviolet absorber may be selected from materials commonly used as ultraviolet absorbers for general plastics, or may be light compounds or inorganic nanomaterials that absorb wavelengths below 400 nm. Examples of the ultraviolet absorber include, but are not limited to, benzophenone-based compounds, salicylates-based compounds, benzotriazole-based compounds, triazine-based compounds, and the like. By adding the ultraviolet absorber, the yellowing and deterioration of the material of the polyimide resin due to ultraviolet irradiation can be suppressed. In a preferred embodiment, the transparent polyimide film does not contain an infrared absorber. The infrared absorber can be a blue infrared absorber, such as: cesium tungsten oxide, tungsten oxide, Prussian blue, tin antimony oxide.

<Device Protection Layer>

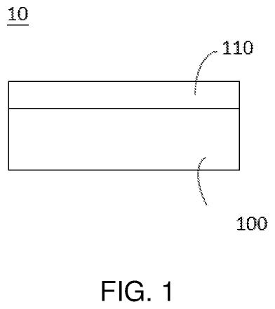

The device protective layer of the present invention is formed by curing the hard coating composition, and the device protective layer is disposed on at least one side of the transparent polyimide film. As shown in FIG. 1, the hard coating composition of the present invention is coated on at least one surface of the transparent polyimide film 100 and cured by ultraviolet light or heating to form the device protection layer 110. The coating method can be a conventional coating method, including slot coating, spin coating or inkjet printing, but is not limited thereto. In the present invention, the hard coating composition comprises a hydrophobic UV-curable resin, an antistatic agent, a compound with three or more reactive functional groups, an elastic oligomer, an initiator and a modified inorganic nanoparticle. Based on the total weight of the hard coating composition, the total content of the compound with three or more reactive functional groups, the elastic oligomer and the initiator is preferably 10 wt % to 95 wt %, such as: 15 wt % to 90 wt %. The content of the hydrophobic UV-curable resin is preferably 0.1 wt % to 10 wt %, based on the total weight of the hard coating composition. In a preferred embodiment, the hard coating composition does not contain fluorescent colorants. In some embodiments, the surface of the device protective layer has hydrophobicity with a water drop angle of greater than 105°.

The composition can be cured by ultraviolet light. For example, the composition is irradiated with ultraviolet light having a wavelength of 312 nm to 365 nm and an energy of 100 to 10,000 mJ/cm², so that the components in the composition undergo a cross-linking reaction to be cured. By heating to be cured, the composition is baked at 150° C. to 200° C., and the components in the composition undergo a crosslinking reaction and are cured. In the present invention, when the thickness of the device protective layer is, for example, 1 μm to 30 μm, it has excellent pencil hardness (e.g., 7H to 9H), and can be folded 100,000 times with a folding radius of 1 mm.

<Hydrophobic UV-Curable Resin (Hydrophobic Ultraviolet Light-Cured Resin)>

The hydrophobic UV-curable resin includes, but is not limited to, a fluorine-based UV-curable resin or a fluoro-polysiloxane-based UV-curable resin. The fluorine-based UV curable resin may be a fluorine-based acrylic monomer. The fluoro-polysiloxane-based UV-curable resin can be a fluoro-polysiloxane-based acrylic monomer. The fluorine groups contained in these UV-curable resins include, but are not limited to: fluoroolefin groups (such as fluoroethylene, vinylidene fluoride, tetrafluoroethylene, hexafluoropropenyl, perfluorobutadienyl, perfluoro-2,2-dimethyl-1,3-dioxole group. The fluorine-based acrylic monomer may be a (meth)acrylate compound having a fluorine atom in the molecule. Examples of the (meth)acrylate compound having a fluorine atom in the molecule include, but are not limited to: 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, α-trifluoro(meth)methylacrylate. The (meth)acrylate compound having a fluorine atom in the molecule can also be a fluorine-containing polyfunctional (meth)acrylate compound, which includes in the molecule: (1) a C₁₋₁₄ fluoroalkyl, fluorocycloalkyl or fluoroalkylene having at least 3 fluorine atoms; and (2) at least 2 (meth)acryloyloxy groups. The fluorine groups contained in these UV-curable resins can also be fluoropolymer groups or oligomer groups with fluorinated alkylene groups on the main chain. The fluorine groups contained in these UV-curable resins can also be fluorinated polymer groups, oligomer groups, etc. with fluorinated alkylene groups or fluorinated alkyl groups on the main chain and branched chains. The polysiloxane part of the above fluorine-polysiloxane-based UV-curable resin structure includes but is not limited to: (poly)dimethylsiloxane, (poly)diethylsiloxane, (poly)diphenylsiloxane, (poly)methylphenylsiloxane, alkyl modified (poly)dimethylsiloxane, (poly)dimethylsiloxane containing an azo group, dimethylpolysiloxane, phenyl methyl polysiloxane, alkyl-aralkyl-modified polysiloxane, fluoropolysiloxane, polyether-modified polysiloxane, fatty acid ester-modified polysiloxane, methyl hydrogen polysiloxane, silanol-containing polysiloxane, alkoxy-containing polysiloxane, polysiloxane containing a phenol group, methacrylic acid modified polysiloxane, acrylic acid modified polysiloxane, amine group modified polysiloxane, carboxylic acid modified polysiloxane, methanol modified polysiloxane, epoxy modified polysiloxane, mercapto modified polysiloxane, fluorine modified polysiloxane, polyether modified polysiloxane, etc. Among them, those having a dimethylsiloxane structure are preferred.

<Antistatic Agent>

Examples of the antistatic agent include, but are not limited to: cationic copolymers with side groups having quaternary ammonium salt groups, negative ionic compounds containing polystyrene sulfonic acid, compounds with polyalkylene oxide chains (preferably polyethylene oxide chain, polypropylene oxide chain), non-ionic polymers (such as: polyethylene glycol methacrylate copolymer, polyether ester amide, polyether amide imide, polyether ester, ethylene oxide-epichlorohydrin copolymer), π-conjugated conductive polymers. These antistatic agents may be used alone or in combination of two or more thereof. In a preferred embodiment, the antistatic agent is an organic salt compound with a conductivity of greater than or equal to 0.1 mS/cm.

<Compound with Three or More Reactive Functional Groups>

This compound with three or more reactive functional groups includes compounds with three or more (meth)acrylate groups. Examples of the compound with three or more reactive functional groups include, but are not limited to: dipentaerythritolhexaacrylate, pentaerythritoltriacrylate, dipentaerythritoltriacrylate, dipentaerythritolacrylate, pentaerythritolhexaacrylate, trimethylolpropane triacrylate, trimethallyl isocyanurate, triallyl isocyanurate, tetramethyltetravinylcyclotetrasiloxane, ethoxylated trimethylolpropane triacrylate (TMPEOTA), propoxylated glycerol triacrylate (GPTA), pentaerythritol tetra acrylates (PETA), pentaerythritol Tri(meth)acrylate, pentaerythritol tetra(meth)acrylate, dipentaerythritol penta(meth)acrylate, pentaerythritol tri(meth)acrylate, dipentaerythritol penta(meth)acrylate, tripentaerythritol hepta(meth)acrylate. These compounds may be used alone or in combination of two or more thereof, depending on needs.

<Elastic Oligomer>

The elastic oligomers comprise oligomers of urethane (meth)acrylates or oligomers of silicon-containing urethane (meth)acrylates, which can be obtained by reacting hydroxy(meth)acrylates with diisocyanates. The hydroxy(meth)acrylate can be synthesized from (meth)acrylate or acryl-containing compound and polyol. (Meth)acrylate can be methyl (meth)acrylate, ethyl (meth)acrylate, isopropyl (meth)acrylate, butyl (meth)acrylate or cyclohexyl (meth)acrylate. The polyol can be ethylene glycol, 1,3 propylene glycol, diethylene glycol, neopentyl glycol, 1,4-butanediol, 1,6-hexanediol, 1,5-pentanediol, trimethylol propane, glycerol, 1,3,5-triol, pentaerythritol, dipentaerythritol, etc. The diisocyanate may be hexamethylene diisocyanate, 2,4-toluene diisocyanate, xylene diisocyanate, trimethyl hexamethylene diisocyanate, 4-diphenylmethane diisocyanate, 1,5 naphthalene diisocyanate and the like. Commercially available urethane (meth)acrylate oligomers can also be used, such as: U-2PPA, U10-HA, U10-PA, UA-1100H, UA-15HA, UA-33H, U-200PA, UA-290TM, UA-160TM, UA-122P, etc. produced by Shin Nakamura Chemical Industry Co.; UO22-081, UO26-001, UO22-162, UO52-002, UO26-012, UO22-312 etc. produced by SUN PROSPER CHEMICALS LIMITED. The molecular weight of the elastic oligomer ranges preferably from 500 g/mol to 5000 g/mol, such as: 520 g/mol to 4800 g/mol, 550 g/mol to 4500 g/mol. The content of the elastic oligomer is preferably 0.1 wt % to 80 wt %, based on the total weight of the hard coating composition.

<Initiator>

The initiator includes a photoinitiator or a thermal initiator, and may be used alone or in combination of two or more. The compounding amount of the compound with three or more reactive functional groups and the initiator is not particularly limited. Generally speaking, the composition ratio of the compound with three or more reactive functional groups and the initiator ranges preferably 5:1 to 100:1. In addition, based on the total weight of the hard coating composition, the content of the compound with three or more reactive functional groups, the elastic oligomer and the initiator is, for example, 10 wt % to 95 wt %. If the amount of the initiator is above the above-mentioned lower limit, the degree of polymerization can be maintained to a certain extent, and the polymer formed by the monomers can retain the high-molecular properties. If the amount of the initiator is below the above-mentioned upper limit, the polymer formed by the monomer will not have the problem of excessively high polymerization and brittleness. If the amount of the monomer with UV-curable groups is too low, the degree of crosslinking of the polymer is insufficient and the polymer cannot be cured. If the proportion of the monomer with UV-curable groups is too high, the polymer is brittle.

Photoinitiators suitable for use in the present invention include, but are not limited to: acetophenones, such as 2-methyl-1-(4-(methylthio)phenyl) morpholino-propane, 1-hydroxycyclohexyl phenyl ketone, diethoxyacetophenone, 2-hydroxy-2-methyl-1-phenylpropane-1-one, 2-benzyl-2-(dimethylamino)-1-[4-(morpholinyl)phenyl]-1-butanone, other suitable acetophenones; benzoins such as benzoin, benzoin methyl ether, benzyl dimethyl ketal, other suitable benzoins; diphenylketones, such as benzophenone, 4-phenyl benzophenone, hydroxyl benzophenone or other suitable benzophenone; thioxanthones, such as isopropyl thioxanthone, 2-chlorothioxanthone or other suitable thioxanthone; anthraquinones, such as 2-ethylanthraquinone or other suitable anthraquinone. In addition to using alone, the above-mentioned photoinitiators can also be used in a mixture of two or more, depending on the needs of users. For example, in order to obtain a quick photosensitive speed, isopropyl thioxanthone can be mixed with 2-tolyl-2-(dimethylamino)-1-[4-(morpholinyl)phenyl]-1-butyl-1-one to be used as the photoinitiator.

Thermal initiators suitable for the present invention include, but are not limited to: azos, such as 2,2′-azobis (2,4-dimethyl valeronitrile), dimethyl 2,2′-azobis (2-methylpropionate), 2,2-azobisiso butyronitrile (AIBN), 2,2-azobis(2-methylisobutyronitrile), 1,1′-azobis(cyclohexane-1-carbonitrile), 2,2′-azobis[N-(2-propenyl)-2-methyl propionamide], 1-[(cyano-1-methylethyl)azo]formamide, 2,2′-azobis(N-butyl-2-methylpropionamide), 2,2′-azobis (N-cyclohexyl-2-methylpropionamide or other suitable azo initiators; peroxides, such as benzoyl peroxide, 1,1-bis(tert-butylperoxy)cyclohexane, 2,5-bis(tert-butylperoxy)-2,5-dimethylcyclohexane, 2,5-bis(tert-butylperoxy)-2,5-dimethyl-3-cyclohexyne, bis(1-(tert-butylpeorxy)-1-methyethyl) benzene, tert-butyl hydroperoxide, tert-butyl peroxide, tert-butyl peroxybenzoate, cumene hydroperoxide, cyclohexanone peroxide, dicumyl peroxide, lauroyl peroxide or other suitable peroxides. The above-mentioned thermal initiators may be used alone or in combination of two or more, depending on needs.

<Modified Inorganic Nanoparticle>

The modified inorganic nanoparticle can be obtained through reaction of reactive components comprising an unmodified inorganic nanoparticle and a modifying agent. In the reactive components, the content of the unmodified inorganic nanoparticle is preferably 90-98 wt %; the content of the modifying agent is preferably 2-10 wt %. The unmodified inorganic nanoparticle suitable for the present invention include, but are not limited to, metal oxide inorganic nanoparticles such as titanium dioxide, silicon dioxide, zirconium oxide, zinc oxide, and aluminum oxide etc. The modifying agent suitable for use in the present invention may be silane coupling agents, which are organosilicon compounds containing chlorosilanes, alkoxysilanes or silazanes. The functional groups contained in the silane coupling agent may include vinyl, methacryloyloxy, acryloyloxy, amine, urea, chloropropyl, mercapto, polysulfide or isocyanate, but are not limited thereto. Examples of silane coupling agents may include, but are not limited to: vinyltrichlorosilane, vinyltrimethoxysilane, vinyltriethoxysilane, 3-methacryloyloxypropyl-methyldimethoxysilane, 3-methacryloyloxypropyl-trimethoxysilane, 3-methacryloyloxypropyl-methyldiethoxysilane, 3-methacryloyloxypropyl-triethoxysilane, 3-acryloyloxypropyltrimethoxysilane, N-(2-aminoethyl)-3-aminopropylmethyldimethoxysilane, N-(2-aminoethyl)-3-aminopropyl trimethoxysilane, N-(2-aminoethyl)-3-aminopropyltriethoxysilane, 3-aminopropyltrimethoxysilane, 3-aminopropyltriethoxysilane, N-benzene aminopropyltrimethoxysilane, 3-chloropropyltriethoxysilane, 3-mercaptopropyltrimethoxysilane, bis(triethoxysilylpropyl)tetrasulfide, 3-isocyanatopropyltriethoxysilane.

In the present invention, the mixing method of the modified inorganic nanoparticle and the mixture of the monomer with UV-curable groups and the initiator is not particularly limited. Generally, ball milling, screw, planetary mixing or stirring can be used to make it evenly mixed. The content of the modified inorganic nanoparticle is preferably 0.1 wt % to 60 wt % based on the total weight of the hard coating composition.

In a preferred embodiment, the hard coating composition does not contain a perfluoropolyether polymer. In certain embodiments, the hard coating composition does not include (meth)acrylate monomers with alkylene oxide repeating units, mono(meth)acrylate monomers with perfluoropolyether groups or a combination thereof. In certain embodiments, the hard coating composition does not include a quaternary ammonium salt-containing polymer.

In a preferred embodiment, after the flexible display cover substrate is brushed with steel wool or an eraser, the water drop angle can be kept more than or equal to 100°, such as: 101°, 102°, 104°.

After the flexible display cover substrate of the present invention is folded with a radius of curvature (for example, 1 mm), it will not cause surface cracks on the device protective layer or breakage of the substrate.

Hereinafter, the present invention will be described in detail by way of Examples and Comparative Examples. However, the following Examples and Comparative Examples are not intended to limit the present invention.

### Preparation Example

The modified inorganic nanoparticle in the hard coating composition was obtained by the following method: 1 part by weight of the unmodified silica nanoparticle solution, in which the content of the unmodified silica nanoparticle is 0.5 wt %, and 0.01 part by weight of 3-methacryloyloxypropyl-trimethoxysilane were mixed and heated at 50° C. for 4 hours under nitrogen for modification. After the reaction was completed, the temperature was lowered to room temperature, and 0.133 parts by weight of pentaerythritol hexaacrylate and 0.133 parts by weight of the elastic oligomer UA-160TM were added into 1 part by weight of the modified nanoparticle solution and stirred for 30 minutes, followed by solution phase inversion according to the required solvent. Finally, 1.5 parts by weight of the modified inorganic nanoparticle solution, 0.03 parts by weight of 2-methyl-1-(4-(methylthiol)phenyl-2-morpholinyl propyl ketone) and 0.01 part by weight of a leveling agent were mixed, and ethyl acetate was added as a solvent to obtain a mixture with a solid content of 55%. The hard coating compositions used in the subsequent Examples and Comparative Examples were prepared using the mixture.

### Example 1

1.1 g of hydrophobic UV-curable resin (10% by weight dissolved in butanone) and 1.1 g of the antistatic agent (10% by weight dissolved in butanone) were added into 20 g of the mixture prepared in the above Preparation Example. After stirring and mixing for 30 minutes, the resulting mixture was spin coated on the surface of a transparent polyimide (CPI) film at 250 rpm for 10 seconds, soft baked at 90° C. for 5 minutes, and then cured by exposure to UV light at 4000 mJ/cm².

### Example 2

3.3 g of hydrophobic UV-curable resin (10% by weight dissolved in butanone) and 1.1 g of the antistatic agent (10% by weight dissolved in butanone) were added into 20 g of the mixture prepared in the above Preparation Example. After stirring and mixing for 30 minutes, the resulting mixture was spin coated on the surface of a transparent polyimide (CPI) film at 250 rpm for 10 seconds, soft baked at 90° C. for 5 minutes, and then cured by exposure to UV light at 4000 mJ/cm².

### Example 3

5.5 g of hydrophobic UV-curable resin (10% by weight dissolved in butanone) and 1.1 g of the antistatic agent (10% by weight dissolved in butanone) were added into 20 g of the mixture prepared in the above Preparation Example. After stirring and mixing for 30 minutes, the resulting mixture was spin coated on the surface of a transparent polyimide (CPI) film at 250 rpm for 10 seconds, soft baked at 90° C. for 5 minutes, and then cured by exposure to UV light at 4000 mJ/cm².

### Example 4

3.3 g of hydrophobic UV-curable resin (10% by weight dissolved in butanone) and 3.3 g of the antistatic agent (10% by weight dissolved in butanone) were added into 20 g of the mixture prepared in the above Preparation Example. After stirring and mixing for 30 minutes, the resulting mixture was spin coated on the surface of a transparent polyimide (CPI) film at 250 rpm for 10 seconds, soft baked at 90° C. for 5 minutes, and then cured by exposure to UV light at 4000 mJ/cm².

### Example 5

A mixture having a solid content of 55% was prepared according to the same method of the aforementioned Preparation Example, except that the weight parts of pentaerythritol hexaacrylate and the elastic oligomer UA160-TM were changed to 0.2128 weight part and 0.0532 weight part respectively. 3.3 g of hydrophobic acrylic monomer (10% by weight dissolved in butanone) serving as the hydrophobic UV-curable resin and 3.3 g of the antistatic agent (10% by weight dissolved in butanone) were added into 20 g of the mixture. After stirring and mixing for 30 minutes, the resulting mixture was spin coated on the surface of a transparent polyimide (CPI) substrate at 250 rpm for 10 seconds, soft baked at 90° C. for 5 minutes, and then cured by exposure to 4000 mJ/cm².

### Example 6

A mixture having a solid content of 55% was prepared according to the same method of the aforementioned Preparation Example, except that the weight parts of pentaerythritol hexaacrylate and the elastic oligomer UA160-TM were changed to 0.1995 weight part and 0.0665 weight part respectively. 3.3 g of hydrophobic acrylic monomer (10% by weight dissolved in butanone) serving as the hydrophobic UV-curable resin and 1.1 g of the antistatic agent (10% by weight dissolved in butanone) were added into 20 g of the mixture. After stirring and mixing for 30 minutes, the resulting mixture was spin coated on the surface of a transparent polyimide (CPI) substrate at 250 rpm for 10 seconds, soft baked at 90° C. for 5 minutes, and then cured by exposure to 4000 mJ/cm².

### Example 7

A mixture having a solid content of 55% was prepared according to the same method of the aforementioned Preparation Example, except that the weight parts of pentaerythritol hexaacrylate and the elastic oligomer UA160-TM were changed to 0.0665 weight part and 0.1995 weight part respectively. 3.3 g of hydrophobic acrylic monomer (10% by weight dissolved in butanone) serving as the hydrophobic UV-curable resin and 1.1 g of the antistatic agent (10% by weight dissolved in butanone) were added into 20 g of the mixture. After stirring and mixing for 30 minutes, the resulting mixture was spin coated on the surface of a transparent polyimide (CPI) substrate at 250 rpm for 10 seconds, soft baked at 90° C. for 5 minutes, and then cured by exposure to 4000 mJ/cm².

### Example 8

A mixture having a solid content of 55% was prepared according to the same method of the aforementioned Preparation Example, except that the weight parts of pentaerythritol hexaacrylate and the elastic oligomer UA160-TM were changed to 0.0532 weight part and 0.2128 weight part respectively. 3.3 g of hydrophobic acrylic monomer (10% by weight dissolved in butanone) serving as the hydrophobic UV-curable resin and 1.1 g of the antistatic agent (10% by weight dissolved in butanone) were added into 20 g of the mixture. After stirring and mixing for 30 minutes, the resulting mixture was spin coated on the surface of a transparent polyimide (CPI) substrate at 250 rpm for 10 seconds, soft baked at 90° C. for 5 minutes, and then cured by exposure to 4000 mJ/cm².

### Comparative Example 1

3.3 g of hydrophobic UV-curable resin (10% by weight dissolved in butanone) was added into 20 g of the mixture prepared in the above Preparation Example. After stirring and mixing for 30 minutes, the resulting mixture was spin coated on the surface of a transparent polyimide (CPI) film at 250 rpm for 10 seconds, soft baked at 90° C. for 5 minutes, and then cured by exposure to UV light at 4000 mJ/cm².

### Comparative Example 2

3.3 g of the antistatic agent (10% by weight dissolved in butanone) was added into 20 g of the mixture prepared in the above Preparation Example. After stirring and mixing for 30 minutes, the resulting mixture was spin coated on the surface of a transparent polyimide (CPI) film at 250 rpm for 10 seconds, soft baked at 90° C. for 5 minutes, and then cured by exposure to UV light at 4000 mJ/cm².

### Comparative Example 3

A mixture having a solid content of 55% was prepared according to the same method of the aforementioned Preparation Example, except that the weight parts of pentaerythritol hexaacrylate and the elastic oligomer UA160-TM were changed to 0.2217 weight part and 0.0443 weight part respectively. 3.3 g of hydrophobic acrylic monomer (10% by weight dissolved in butanone) serving as the hydrophobic UV-curable resin and 1.1 g of the antistatic agent (10% by weight dissolved in butanone) were added into 20 g of the mixture. After stirring and mixing for 30 minutes, the resulting mixture was spin coated on the surface of a transparent polyimide (CPI) substrate at 250 rpm for 10 seconds, soft baked at 90° C. for 5 minutes, and then cured by exposure to 4000 mJ/cm².

### Comparative Example 4

A mixture having a solid content of 55% was prepared according to the same method of the aforementioned Preparation Example, except that the weight parts of pentaerythritol hexaacrylate and the elastic oligomer UA160-TM were changed to 0.0443 weight part and 0.2217 weight part respectively. 3.3 g of hydrophobic acrylic monomer (10% by weight dissolved in butanone) serving as the hydrophobic UV-curable resin and 1.1 g of the antistatic agent (10% by weight dissolved in butanone) were added into 20 g of the mixture. After stirring and mixing for 30 minutes, the resulting mixture was spin coated on the surface of a transparent polyimide (CPI) substrate at 250 rpm for 10 seconds, soft baked at 90° C. for 5 minutes, and then cured by exposure to 4000 mJ/cm².

Performance Evaluation

Thickness Measurement

The thickness of each transparent polyimide film was measured by contact with a thickness gauge, and then the thickness of the device protective layer formed from the hard coating composition on the transparent polyimide film was measured by Alpha Step.

Steel Wool Brush Test

By using a reciprocating abrasion tester, 2×2 cm of steel wool SW #0000 was used to brush a fixed area on the cover substrate at a speed of 25 times/min under a load of 1,000 g for 2,500 times, and then the water drop angle of the brushed area was measured.

Eraser Brush Test

By using a reciprocating abrasion tester, an eraser with a diameter of 6 mm (tensile strength=11.91 kgf/cm²) and a hardness of 81 (Durometer A type) was used to brush a fixed area on the cover substrate at a speed of 17 times/min under a load of 1,000 g for 2,500 times, and then the water drop angle of the brushed area was measured.

Determination of Pencil Hardness

Using an electronic pencil hardness tester, a Mitsubishi test pencil was used to draw a line of 10 mm in length at a speed of 30 mm/min under a load of 750 g on each cover substrate for five times, and then the surface scratches were observed and compared with the pencil hardness.

Total Light Transmittance (%) and Haze

The total light transmittance and haze of the cover substrate were measured using a Nippon Denshoku DOH 5500 according to ASTM D1007.

Bending Performance

The cover substrate was attached to a folding tester (YUASA System U-shape Folding) and folded 100,000 times with R=1 mm. First, observe whether the cover substrate was broken or not, and then observe whether the device protective layer had cracks with the naked eye and a microscope. Any breakage of the cover substrate or cracks in the device protective layer was marked as unacceptable (X), and no breakage and cracks was marked as acceptable (O).

The test results of the aforementioned performance evaluation are recorded in Table 1 and Table 2.

TABLE 1

| | | Ex. 1 | Ex. 2 | Ex. 3 | Ex. 4 | Comp. Ex. 1 | Comp. Ex. 2 |
|---|---|---|---|---|---|---|---|
| Hydrophobic UV- | | 1 wt % | 3 wt % | 5 wt % | 3 wt % | 3 wt % | |
| curable resin | | | | | | | |
| Antistatic agent | | 1 wt % | 1 wt % | 1 wt % | 3 wt % | | 3 wt % |
| Compound with | | 92 wt % | 92 wt % | 92 wt % | 92 wt % | 92 wt % | 92 wt % |
| three or more | | | | | | | |
| reactive functional | | | | | | | |
| groups + Elastic | | | | | | | |
| oligomer | | | | | | | |
| Device protection | | | | | | | |
| layer test results | | | | | | | |
| Haze | | <0.5 | <0.5 | <0.5 | <0.5 | <0.5 | <0.5 |
| Water | Initial value | 110 | 111 | 112 | 112 | 113 | 87 |
| drop | After steel | 100 | 102 | 101 | 104 | 102 | 53 |
| angle | wool brush | | | | | | |
| | After eraser | 100 | 100 | 101 | 102 | 76 | 67 |
| | brush | | | | | | |

| | | | | | | |
|---|---|---|---|---|---|---|
| Bending resistance | ◯ | ◯ | ◯ | ◯ | ◯ | ◯ |

TABLE 2

| | | Ex. 5 | Ex. 6 | Ex. 7 | Ex. 8 | Comp. Ex. 3 | Comp. Ex. 4 |
|---|---|---|---|---|---|---|---|
| Hydrophobic UV- | | 3 wt % | 3 wt % | 3 wt % | 3 wt % | 3 wt % | 3 wt % |
| curable resin | | | | | | | |
| Antistatic agent | | 1 wt % | 1 wt % | 1 wt % | 1 wt % | 1 wt % | 1 wt % |
| Compound with | | 4/1 | 3/1 | 1/3 | 1/4 | 5/1 | 1/5 |
| three or more | | | | | | | |
| reactive functional | | | | | | | |
| groups + Elastic | | | | | | | |
| oligomer (wt/wt) | | | | | | | |
| Device protection | | | | | | | |
| layer test results | | | | | | | |
| Haze | | <0.5 | <0.5 | <0.5 | <0.5 | >0.5 | <0.5 |
| Water | Initial value | 108 | 110 | 109 | 109 | 109 | 108 |
| drop | After steel | 101 | 102 | 101 | 101 | 86 | 90 |
| angle | wool brush | | | | | | |
| | After eraser | 100 | 100 | 101 | 102 | 65 | 73 |
| | brush | | | | | | |

| | | | | | | |
|---|---|---|---|---|---|---|
| Bending resistance | ◯ | ◯ | ◯ | ◯ | ◯ | X |

As shown in table 1, compared with Comparative Examples 1 and 2, Examples 1 to 4 can obtain no less than 100 degrees of water drop angles after brushing with an eraser meanwhile maintaining a certain level of haze and bending resistance. This fact proves that the hard coating composition of the present invention has unexpected effects.

As shown in Table 2, compared with Comparative Example 3 and Comparative Example 4, Examples 5 to 8 have good haze and bending resistance because their weight ratios of the compounds with three or more reactive functional groups to the elastic oligomers ranges from 0.25 to 3.

It can be seen from the above, according to the present invention, a flexible display cover substrate with low haze and good bending resistance can be obtained.

Those described above are only the preferred embodiments of the present invention, and are not intended to limit the present invention. It should be pointed out that for people having ordinary skill in the art, several improvements and modifications can be made without departing from the technical principle of the present invention, and these improvements and modifications should also be regarded as the protection scope of the present invention.

What is claimed is:

1. A flexible display cover substrate, comprising
a transparent polyimide film; and
a device protection layer formed by curing a hard coating composition and disposed on at least one surface of the transparent polyimide film, and the hard coating composition including a hydrophobic UV-curable resin, an antistatic agent, a compound with three or more reactive functional groups, an elastic oligomer, an initiator and a modified inorganic nanoparticle,
wherein a weight ratio of the compound with three or more reactive functional groups to the elastic oligomer ranges from 0.25 to 3.

2. The flexible display cover substrate of claim 1, wherein the hydrophobic UV-curable resin comprises a fluorine-based UV-curable resin or a fluorine-polysiloxane-based UV-curable resin.

3. The flexible display cover substrate of claim 1, wherein the hydrophobic UV-curable resin accounts for 0.1 to 10 wt % of a total amount of the hard coating composition.

4. The flexible display cover substrate of claim 1, wherein the antistatic agent comprises an organic salt compound.

5. The flexible display cover substrate of claim 1, wherein the antistatic agent accounts for 0.1 to 5 wt % of a total amount of the hard coating composition.

6. The flexible display cover substrate of claim 1, wherein the compound with three or more reactive functional groups comprises a compound having three or more (meth)acrylate groups.

7. The flexible display cover substrate of claim 1, wherein the elastic oligomer comprises an urethane (meth)acrylate oligomer or an oligomer of urethane (meth)acrylates containing silicon.

8. The flexible display cover substrate of claim 1, wherein the modified inorganic nanoparticle comprises an inorganic nanoparticle modified with a silane coupling agent.

9. The flexible display cover substrate of claim 1, wherein a total amount of the compound with three or more reactive functional groups, the elastic oligomer and the initiator accounts for 10 to 95 wt % of a total amount of the hard coating composition.

10. The flexible display cover substrate of claim 1, having a water drop angle of greater than 105°.

11. The flexible display cover substrate of claim 1, having a water drop angle of 100° or more after being brushed with an eraser.
